(19) United States
(12) Patent Application Publication
(10) Pub. No.: US 2007/0246338 A1
(43) Pub. Date: Oct. 25, 2007

(54) Double safety control device for a push switch

(76) Inventor: Fu Hsiung Lee, Daya Township (TW)

Correspondence Address: CHARLES E. BAXLEY, ESQ., 90 JOHN STREET, THIRD FLOOR, NEW YORK, NY, 10038, US

(21) Appl. No.: 11/545,973

(22) Filed: Oct. 10, 2006

(30) Foreign Application Priority Data
Apr. 21, 2006 (CN) 095206837

(51) Int. Cl. H01H 9/20

(52) U.S. Cl. 200/334

(57) ABSTRACT

A double safety control device for a push switch comprises: a body, a conducting seat, a plurality of push buttons, a guiding plate, a positioning piece, a spring, a safety leaf spring, and a connecting member for connecting to power source. The respective components are positioned on the body, the push buttons serve to press the conducting seats, the connecting member is arranged at a predetermined distance away from the safety leaf spring, the guiding plate is formed with slant protrusions to be pressed by the push buttons, and the guiding plate cooperates with the spring and the isolating protruding member to push the safety leaf spring. With the arrangement of the abovementioned components, the safety leaf spring of the present invention can activate the power source after the switch pressing action is confirmed, thus preventing the occurrence of electricity leakage.

### BACKGROUND OF THE INVENTION

1. Field of the Invention

The present invention relates to a push switch, and more particularly to a double safety control device for a push switch that can prevent the occurrence of electricity leakage of an electric appliance's circuit and can activate the power source after the switch pressing action is confirmed. The safety leaf spring will activate the power source only after the push button is pressed to a predetermined position, thus preventing the occurrence of electricity leakage when a single wire power source is activated.

2. Description of the Prior Art

Nowadays, more and more household electrical appliances are using push-button system to perform operation control, and the spirit of the push-button control system is precision control. However, the push button of the electric appliance commonly seen on the market is usually connected to the power source directly, and the power source will be activated by slightly pressing the push button. This conventional push-button control system has been used for a long period of time, however, it still has the following problems:

First, since the push button of the electric appliance commonly seen on the market is directly connected to the power source, and if the push button gets loose accidentally, the power source is turned on, or short circuit occurs, the user might be electrically shocked by the electricity leakage.

Second, the push button of an ordinary electric appliance usually protrudes out of the surface of the product, it often becomes the target of children's curiosity. Children don't have enough strength to press down the push button completely, however, the power source will be activated just by slightly pressing the push button. Therefore, the conventional product might cause injury to the children when the product is turned on accidentally.

Third, since the power source of the conventional electric appliance will be activated when the push button is just slightly pressed, the user may wrongly think the press button has been pressed into place even when the press button is not fully pressed. This is labor consuming, and repeatedly turning on/off the power source will also affect the service life of the electric appliance.

The present invention has arisen to mitigate - and/or obviate the afore-described disadvantages.

### SUMMARY OF THE INVENTION

The primary objective of the present invention is to provide a double safety control device for a push switch that can prevent the occurrence of electricity leakage of an electric appliance's circuit. The guiding plate of the present invention will press the safety leaf spring only after the operation is confirmed, and the safety leaf spring is located between the power source and the electric appliance's circuit. When the push button gets loose or the electric appliance circuit is improperly connected, the present invention can use the safety leaf spring to disconnect the power source and prevent the occurrence of electricity leakage.

The secondary objective of the present invention is to provide a double safety control device for a push switch, wherein the push button will activate the power source only after the press action is confirmed, so as to prevent the electricity leakage caused by the conventional single wire switch.

### BRIEF DESCRIPTION OF THE DRAWINGS

FIG. 1 is an exploded view of a double safety control device for a push switch in accordance with the present invention;

FIG. 2 is a cross sectional view of the double safety control device for a push switch in accordance with the present invention;

FIG. 3 is an operational view of the double safety control device for a push switch in accordance with the present invention;

FIG. 4 is an illustrative view of a part of the double safety control device for a push switch in accordance with the present invention;

FIG. 5 is an operational view of showing a part of the double safety control device for a push switch in accordance with the present invention;

FIG. 6 is an illustrative view of a part of the double safety control device for a push switch in accordance with a second embodiment of the present invention;

FIG. 7 is an operational view of showing a part of the double safety control device for a push switch in accordance with a second embodiment of the present invention;

FIG. 8 is an illustrative view of a part of the double safety control device for a push switch in accordance with a third embodiment of the present invention; and

FIG. 9 is an operational view of showing a part of the double safety control device for a push switch in accordance with a third embodiment of the present invention.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

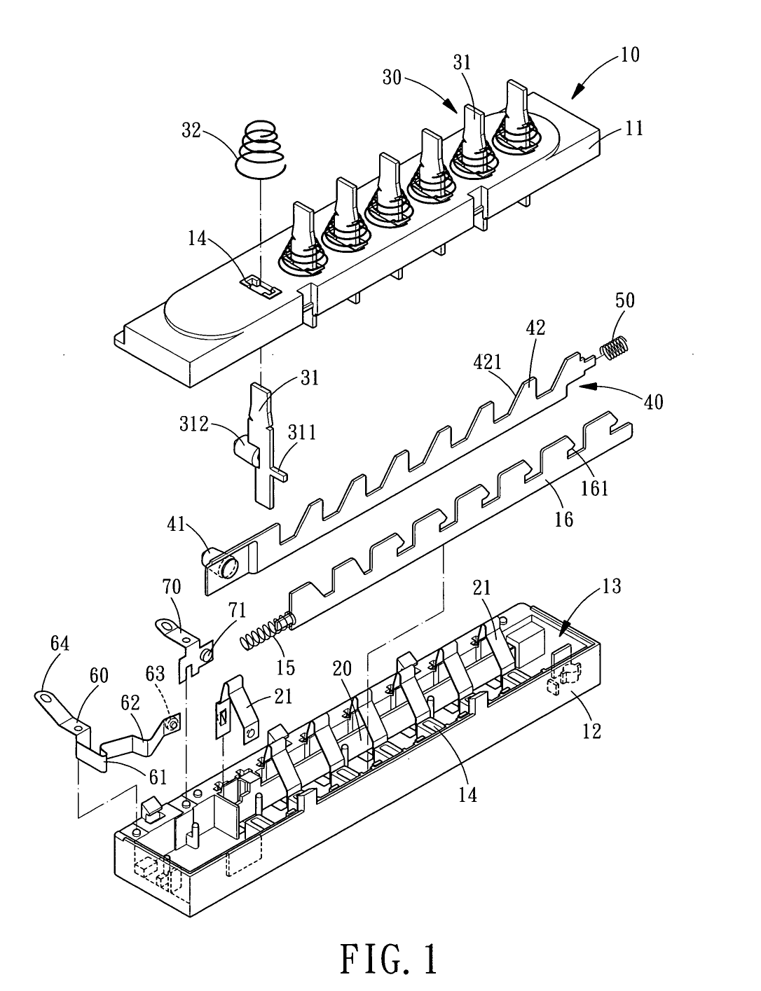

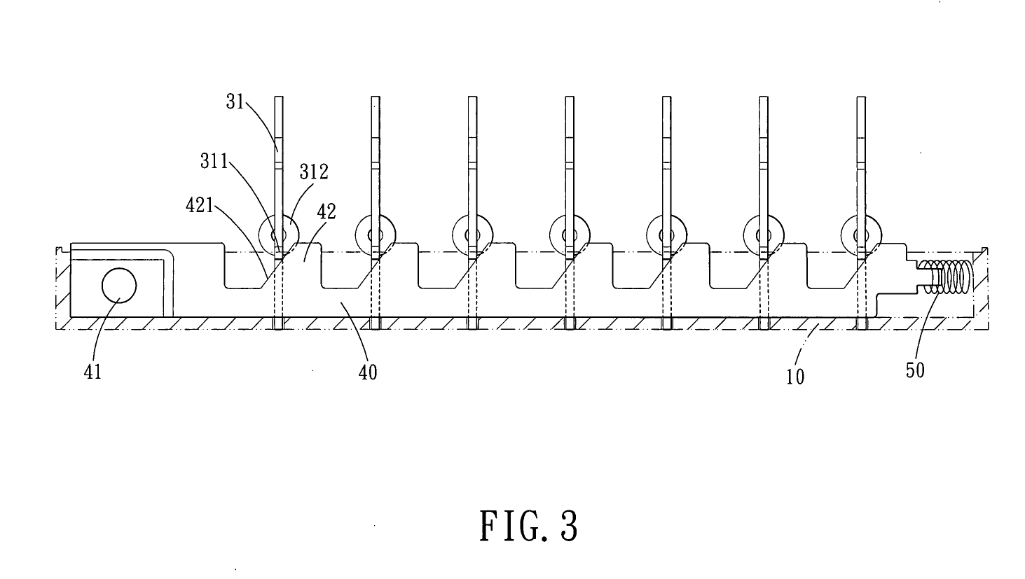

Referring to FIGS. 1-3, a double safety control device for a push switch in accordance with the present invention is shown and comprises a body 10, a conducting seat 20, a plurality of push buttons 30, a guiding plate 40, a spring 50, a safety leaf spring 60, and a connecting member 70 connecting to power source.

The body 10 includes a cover 11 engaged with a base 12. The cover 11 and the base 12 define a receiving space 13, and a plurality of through holes 14 is formed in the cover 11 and the base 12. In the receiving space 13 are slideably received a return spring 15 and a positioning piece 16 having a plurality of hooks 161.

The conducting seat 20 is positioned in the receiving space 13 of the base 10, and on the conducting seat 20 is disposed a plurality of conducting leaf springs 21.

Each of the push buttons 30 includes a plate 31 and a return spring 32. The plate 31 is inserted in the through hole 14 of the base 10, and the return spring 32 is biased between the surface of the body 10 and the protruding end of the plate 31. The plate 31 of the push button 30 is pressed against the conducting leaf spring 21 of the conducting seat 20 via an isolator 312, and a protruding portion 311 of the plate 31 is abutted against the positioning piece 16 of the body 10. When the plate 31 pushes the return spring 32 to move downward, the isolator 312 of the plate 31 will press the conducting leaf spring 21 and make the conducting leaf spring 21 deform, so as to electrify the conducting seat 20. The positioning piece 16 of the body 10 provides an effect for positioning the plate 31 of the push button 30. The up and down motion of the push button 30 and the isolator 312 make the conducting leaf spring 21 of the conducting seat 20 connect or disconnect the electric appliance's circuit.

The guiding plate 40 is slideably disposed in the receiving space 13 of the body 10 in such a manner that an end of the guiding plate 40 is abutted against the inner surface of the body 10 via the spring 50 and another end of the guiding plate 40 is provided with an isolating protruding member 41. On the top side of the guiding plate 40 are formed a plurality of slant protrusions 42 located correspondingly to the plates 31 of the push buttons 30, and the slant surface 421 of the slant protrusions 42 is located against the axial direction of the spring 50. The plates 31 press the slant surfaces 421 of the guiding plate 40, meanwhile, the spring 50 is used to push the guiding plate 40 to move.

The safety leaf spring 60 is engaged in the receiving space 13 of the base 10 and includes a conducting end 64, a bent portion 61, a slant portion 62 and a contacting portion 63. The conducting end 64 is connected to power source circuit. The bent portion 61 uses the slant portion 62 to lift up the contacting portion 63. The slant portion 62 rests on the isolating protruding member 41 and is to be pushed by the movement of the isolating protruding member 41. The contacting portion 63 of the safety leaf spring 60 is to be connected or disconnected to the electric appliance's circuit.

The connecting member 70 is engaged in the receiving space 13 of the body 10 and has an end connected to the power source circuit. At another end of the connecting member 70 is formed a connecting portion 71 located a predetermined distance away from the contacting portion 63 of the safety leaf spring 60. When the slant portion 62 is pushed by the movement of the isolating protruding member 41, the contacting portion 63 will be caused to contact the connecting portion 71.

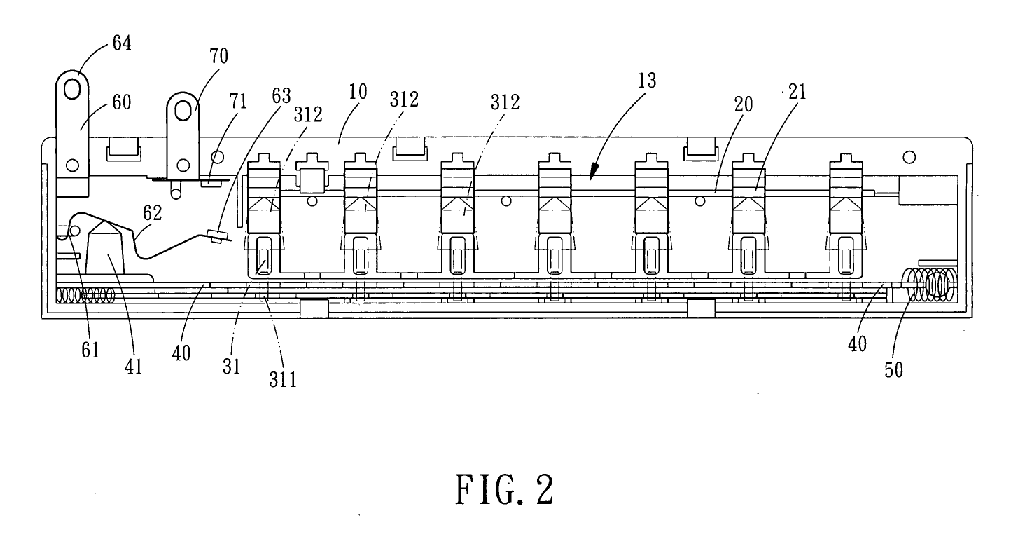

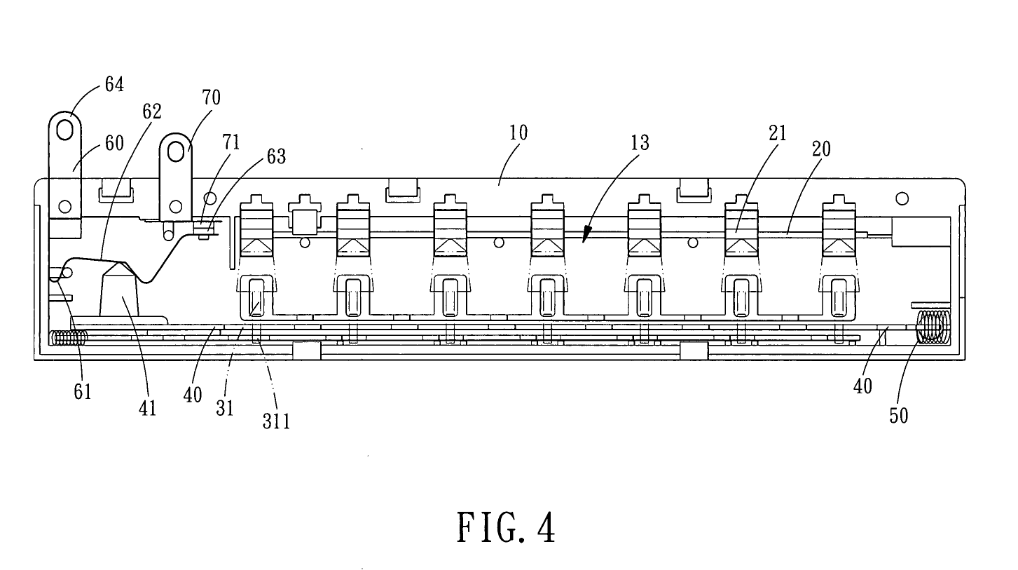

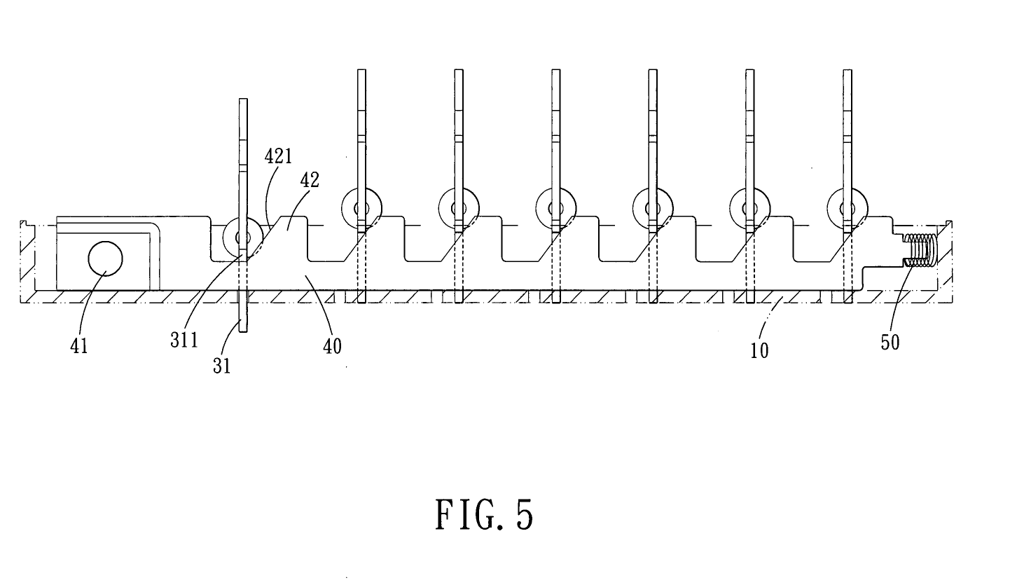

For a better understanding of the present invention, reference should be made to FIGS. 2-5.

When in use, initially the user should press the push button 30 (the plates 31 will push the guiding plate 40 to move by pushing the slant surfaces 421) until the isolators 312 on the plates 31 of the push buttons 30 press the leaf springs 21 and make the conducting seat 20 electrified. Meanwhile, the hooks 161 of the positioning piece 16 will hook the protruding portion 311 of the respective plates 31 of the push buttons 30. When the push buttons 30 are positioned in place in the positioning piece 16, the movement of the guiding plate 40 will also make the isolating protruding member 41 move, and the isolating protruding member 41 will push the slant portion 62 of the safety leaf spring 60 and make the contacting portion 63 contact the connecting portion 71 of the connecting member 70. At this moment, the power source circuit on the contacting portion 63 and the connecting portion 71 is electrified.

It is to be noted that when the electric circuit inside the electric appliance gets loose or the circuit is improperly connected, the present invention can use the safety leaf spring 60 to disconnect the power source and prevent the occurrence of electricity leakage.

In addition to the positioning piece 16 of the return spring 15, the body 10 can further be provided with various controlling pieces according to need, and the operation of the double safety control device of the push button will not be affected.

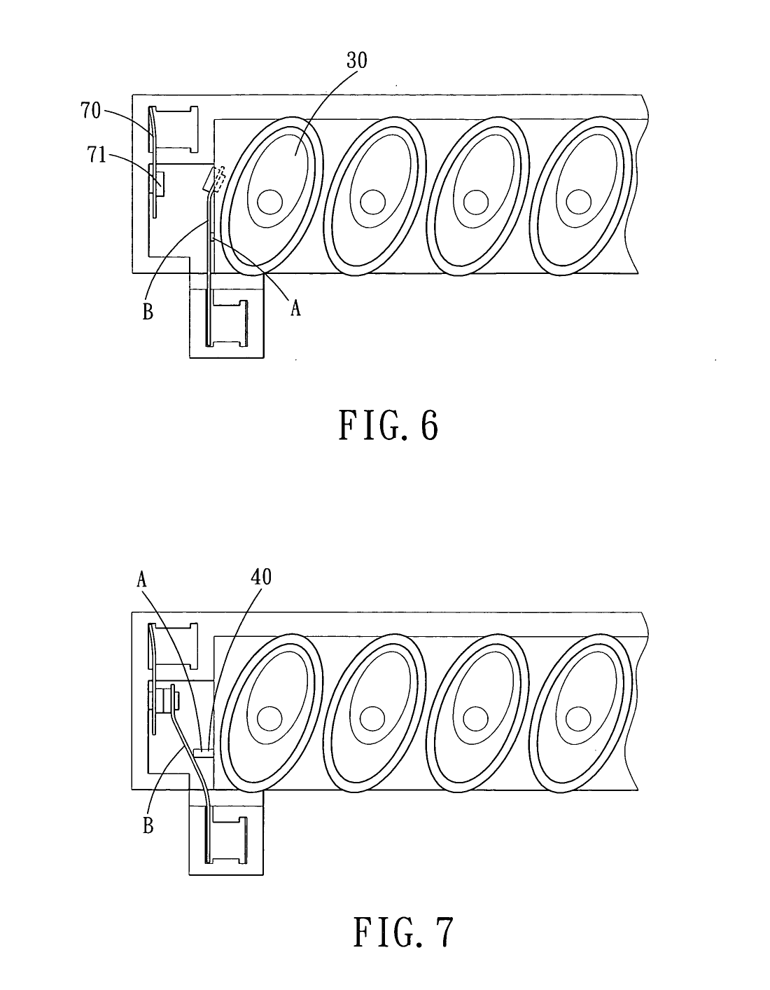

Referring to FIGS. 6 and 7, which show a second embodiment of the present invention. The operation of this embodiment is similar with the first embodiment, the conducting leaf springs 21 are also electrified by pressing the push buttons 30, and meanwhile, the push buttons 30 are also positioned by the positioning piece 16. However, the isolator has been replaced with a swinging type safety leaf spring B that is horizontally arranged and is to be pushed by the end A of the guiding plate 40. The swinging type safety leaf spring B rests on the connecting portion 71 of the connecting member 70. At this moment, the power source circuit on the connecting portion 71 and the swinging type safety leaf spring B is electrified. On the other hand, the return force for making the guiding plate 40 return to its original position is provided by an elastic member (spring), and such a return device is of known technique. The key point of the present invention is to control the turn on/off of the switch by using the end A of the guiding plate 40 to push the swinging type safety leaf spring B.

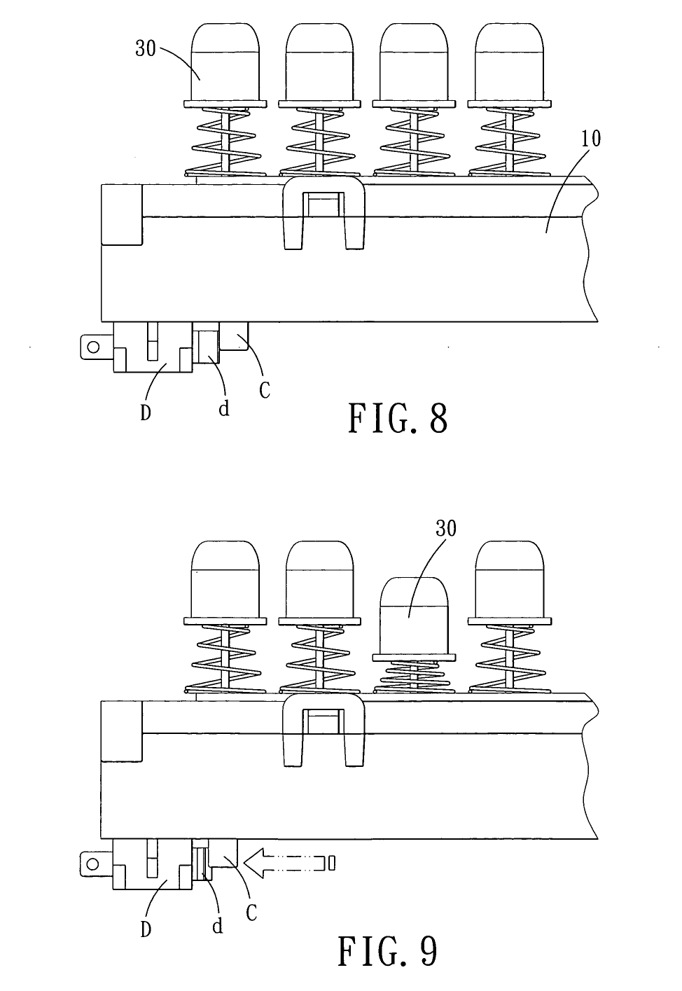

FIGS. 8 and 9 show a third embodiment of the present invention. The operation of this embodiment is similar with the first embodiment, the conducting leaf springs are also electrified by pressing the push buttons 30, and meanwhile, the push buttons 30 are also positioned by the positioning piece 16. However, the isolating protruding member in this embodiment has been replaced with ear portion C that protrudes out of the guiding plate and is to be moveably inserted into a through hole of the body 10. On the body 1 is disposed a proximity switch D having a pressing member d, and the pressing member d serves to press the ear portion C. When the guiding plate is driven to move by push button 30, the ear portion C will be caused to move and press the pressing member d of the proximity switch D, and thus the power source circuit can be connected or disconnected. In addition, the return force for making the guiding plate return to its original position is provided by an elastic member (spring), and such a return device is of known technique.

To summarize, the respective components are positioned on the body, the respective push buttons are employed to press the conducting seats, the connecting member for connecting the power source is arranged at a predetermined distance away from the safety leaf spring, the guiding plate is formed with slant protrusions to be pressed by the push buttons, and the guiding plate cooperates with the spring and the isolating protruding member to push the safety leaf spring. With the arrangement of the abovementioned components, the safety leaf spring of the present invention can activate the power source after the switch pressing action is confirmed, thus preventing the occurrence of electricity leakage.

While we have shown and described various embodiments in accordance with the present invention, it is clear to those skilled in the art that further embodiments may be made without departing from the scope of the present invention.

What is claimed is:

1. A double safety control device for a push switch comprising: a conducting seat, a plurality of push buttons, a guiding plate, a positioning piece, a spring, a safety leaf spring, and a connecting member for connecting to power source, these components being disposed on a body, the push buttons serving to push the guiding plate and the positioning piece, characterized in that:
the push buttons are used to press the conducting seat, the connecting member for connecting to power source is located a distance away from the safety leaf spring, on the guiding plate are formed a plurality of slant protrusions located correspondingly to moving route of the push buttons, pushing the slant protrusions with the pressing buttons can cause the guiding plate to move, a plurality of return springs is biased between the guiding plate and the body, the guiding plate serves to press the safety leaf spring and make the safety leaf spring deform, so that the safety leaf spring will be connected or disconnected to the connecting member for connecting power source.

2. The double safety control device for a push switch as claimed in claim 1, wherein an isolating protruding member is disposed at an end of the guiding plate and serves to press the safety leaf spring and make the safety leaf spring deform, and thus the deformed spring will be connected or disconnected to the connecting member, and electric power can flow to electric appliance circuit via the safety leaf spring.

3. The double safety control device for a push switch as claimed in claim 1, wherein an ear portion protrudes out of the guiding plate and penetrates the body, a through hole is formed in the body for allowing the ear portion to move therein, a proximity switch is disposed on the body and is to be controlled by the ear portion, so that power source will be connected or disconnected.

4. The double safety control device for a push switch as claimed in claim 2, wherein:
a receiving space is defined in the body, and in which is slideably disposed the positioning piece having return springs;
the conducting seat is positioned in the receiving space of the body, on the conducting seat is disposed a plurality of conducting leaf springs;
each of the pushing buttons includes a plate and a return spring, the plate is inserted in the body, the return spring is biased between the body and the plate, the plate of pushing button is pressed against the conducting leaf spring of the conducting seat via an isolator, the plate serves to press the safety leaf spring and make the safety leaf spring deform, the positioning piece of the body serves to position the push buttons after the push buttons are pressed;
the guiding plate is slideably disposed in the receiving space of the body in such a manner that an end of the guiding plate is abutted against an inner surface of the body via the spring and another end of the guiding plate is provided with an isolating protruding member, on a top side of the guiding plate are formed a plurality of slant protrusions located correspondingly to the plate of the push buttons, and a slant surface of the respective slant protrusions is located against an axial direction of the spring, the plate presses the slant surface of the guiding plate, meanwhile, the spring is used to push the guiding plate to move;
the safety leaf spring is engaged in the body and includes a conducting end, a bent portion, a slant portion and an contacting portion, the conducting end is connected to power source circuit, the bent portion uses the slant portion to lift up the contacting portion, the slant portion rests on the isolating protruding member and is to be pushed by the movement of the isolating protruding member, the contacting portion of the safety leaf spring is to be connected or disconnected to electric appliance's circuit;
the connecting member is engaged in the receiving space of the body and has an end connected to the power source circuit, at another end of the connecting member is formed a connecting portion located a predetermined distance away from the contacting portion of the safety leaf spring, when the slant portion is pushed by the movement of the isolating protruding member, the contacting portion will be caused to contact the connecting portion.

5. The double safety control device for a push switch as claimed in claim 4, wherein the body includes a cover engaged with a base, a plurality of through holes is formed in the cover and the base, and the plate of the respective pushing buttons is disposed in the through holes.
